(19) United States
(12) Patent Application Publication
(10) Pub. No.: US 2004/0201589 A1
(43) Pub. Date: Oct. 14, 2004

(54) Method and device for displaying objects

(76) Inventor: Hakan Ekstrom, Linkoping (SE)

Correspondence Address: Swidler Berlin Shereff Friedman, Suite 300, 3000 K Street, NW, Washington, DC, 20007-5116, US

(21) Appl. No.: 10/487,358

(22) PCT Filed: Jun. 26, 2002
(86) PCT No.: PCT/SE02/01269

(30) Foreign Application Priority Data
Aug. 22, 2001 (SE) 0102796-0

(51) Int. Cl. G06T 11/20

(52) U.S. Cl. 345/440

(57) ABSTRACT

The invention concerns a method and a device for displaying surrounding objects on a display surface 1. A first number of objects within selected geographic surroundings are displayed in perspective view 2 on the display surface. Objects that are located outside of the selected geographic surroundings, but within a predetermined distance, are represented by symbols 5 that are displayed in a frame 3 on the periphery of said display surface 1. The placements of the symbols 5 along this frame 3 provide a two-dimensional representation of the actual positions of the objects.

### TECHNICAL AREA

The invention concerns a method for displaying surrounding objects on a display surface. The invention also concerns a device for use in an aircraft to display objects surrounding said aircraft. Using the method and device according to the invention, a first number of objects within selected geographic surroundings is displayed in perspective on the display surface.

### STATE OF THE ART

Visual display systems are used to provide an operator, such as a pilot in an airplane, with information concerning what is happening in the surrounding airspace. One such display system is a perspective display, which consists of a display screen on which a perspective view of the surroundings is displayed. The perspective display is a two-dimensional representation of three-dimensional surroundings. By allowing, e.g. a grid of boxes or points to represent a third dimension on the two-dimensional display surface, a display is created in perspective. One such perspective display is known from, e.g. U.S. Pat. No. 5,257,347, which describes a method and device for generating a perspective representation of surrounding terrain on a two-dimensional display surface.

In a known type of perspective display, objects in the external surroundings are displayed in a way that enables the pilot to form a conception as to his own position relative to external objects by viewing himself from a chosen perspective. Furthermore, objects in the external surroundings can be displayed on a basis of varying size in the field of view, which enables the pilot to obtain an overview of his flight status, or to focus on a limited part of the external surroundings.

In a perspective display, the extent of the perspective is limited horizontally, vertically and in depth. Information about objects located outside of the range of visibility must come from other types of indicators. The limitations of the perspective display entail that the pilot must shift his attention between indicators in order to stay updated regarding his situation vis-a-vis the external surroundings. Since a pilot in a combat aircraft has a multiplicity of instruments in his field of view, this means that it must be easy for him to interpret the instrument readings on displays, and easy to convert those readings into his visualization of his surroundings and his spatial conception. Forcing a pilot to frequently shift his attention among different display types and simultaneously convert data in such an environment can result in a poor overall awareness of his external surroundings.

### DESCRIPTION OF THE INVENTION

The object of the invention is to provide a display system that eliminates the aforementioned problems. In the display method according to the invention, a display surface on a perspective display is used to present a first number of objects within predetermined geographical surroundings. The display is presented from a chosen perspective. Objects that are located outside of the selected geographic surroundings, but within a predetermined distance, are represented by symbols in a frame on the periphery of said display surface. The placements of the objects in this frame provide a two-dimensional representation of the actual positions of the objects.

In a preferred embodiment of the invention, the frame is surrounding the perspective display.

In an embodiment of the invention, the objects are displayed as symbols in the frame. These symbols can be designed so that the nearby objects are displayed most prominently.

In a preferred embodiment of the invention, the symbols are disposed in a manner consistent with their directions, which means that symbols placed in the upper half of the frame are located in front of the object of the user, while symbols placed in the lower half are located behind said object.

The invention also concerns a device for use in an aircraft to display objects surrounding said aircraft. The device comprises a display surface on which a perspective view of selected geographic surroundings is displayed. A frame on the periphery of the display surface represents a chosen environment outside of said geographic surroundings.

In an embodiment of the invention, said frame is semi-transparent and superimposed over the perspective view.

The superimposition of information provides a user-friendly display using two-dimensional information in a perspective view. The pilot thereby avoids having to shift his attention between separate screen displays, and is thus better able to maintain his conception of the positions of other objects in relation to his own, regardless of whether or not they are visible in the perspective view. This enables the pilot to focus his attention, and thereby increases his awareness of the situation.

### BRIEF DESCRIPTION OF FIGURES

FIG. 1 Shows the display system according to the invention in a first perspective.

FIG. 2 Shows the display system according to the invention in a second perspective.

FIG. 3 Shows symbols for objects, and overlapping among same.

### PREFERRED EMBODIMENTS

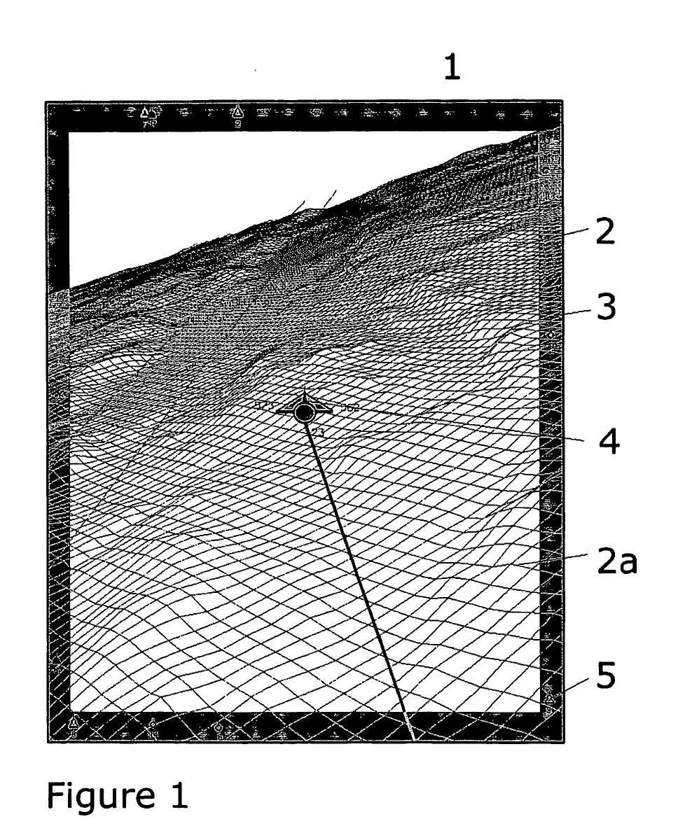

FIG. 1 shows a display surface 1 according to the invention with a perspective view 2 and a surrounding frame 3. The midpoint of the display surface 1 consists of a user symbol 4 that represents the aircraft of the user.

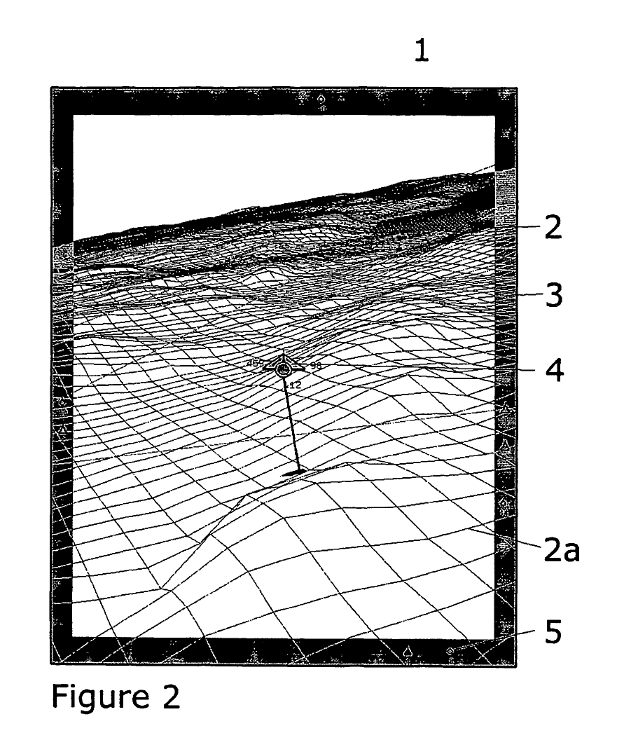

The perspective view 2 is achieved via a grid 2a, which represents the third dimension. The position of the aircraft of the user is identified by a user symbol 4 at the center of the perspective view 2. The perspective can be changed by scaling the grid up or down. Other perspective view options relative to that of the user are of course possible. FIG. 2 shows a second perspective in which the surroundings being displayed in perspective view has been reduced by changing the viewing scale. It is also possible to utilize a larger portion of the view to provide a display in any direction relative to the aircraft.

The perspective display provides a visualization of the position of the aircraft of the user in relation to external objects and the surroundings. In the embodiment shown in the figure, parameters that provide additional information about the speed, altitude and direction of the aircraft of the user are also displayed.

The frame 3 is arranged on the periphery of the perspective view 2. In the embodiments shown, the frame 3 extends uninterrupted around the entire perspective view. The frame can also be interrupted so that one or more fields are created on the periphery of the perspective view. This embodiment may be relevant in connection with target tracking, when information in the direction of flight of the aircraft is of primary relevance.

In the embodiments shown in FIGS. 1 and 2, the frame is semi-transparent and partially overlaps the perspective view. The frame can of course also surround the perspective view without overlapping it, whereupon the frame 3 can encompass the entire view. Alternatively, the frame can be delimited from the perspective view 2 by only a contour line. The frame can then be made transparent. The frame is rectangular in the embodiments shown in FIGS. 1 and 2. This shape is adapted to the shape of the display so that the frame conforms to the edge of the perspective display regardless of whatever geometric shape it may have.

The scale of the frame can be adjusted to that of the perspective view. If the selected perspective is changed, then the scale of the frame can be adjusted accordingly. The perspective view showed in FIG. 1 mirrors more extensive geographical surroundings than is the case for the perspective view shown in FIG. 2. The scale of the frame in FIG. 1 should then be larger than the scale used for the frame in FIG. 2.

A number of symbols 5 are displayed in the semi-transparent frame, which symbols represent aircraft or targets located outside the field of view of the displayed perspective view. The positions of the symbols 5 in the frame 3 are calculated based on the rectangular shape of the frame and the angle of bearing between the object of the user and objects in the external surroundings. If a symbol 5 is located in the upper half of the frame 3, then the object is located in front of the aircraft of the user. The opposite applies if the symbol is located in the lower half of the frame 3.

In the embodiments shown in FIGS. 1 and 2, the symbols 5 are supplemented with an altitude reading that indicates the altitude in meters or thousands of meters. Information concerning range or a combination of altitude and range is also possible. However, it is important that the information be limited so that its clarity and ease of overall comprehension are not lost. In those cases where a plurality of symbols 5 are positioned near to one another, the symbols 5 for those aircraft that are most remote can be toned down so that the most proximate aircraft stand out better.

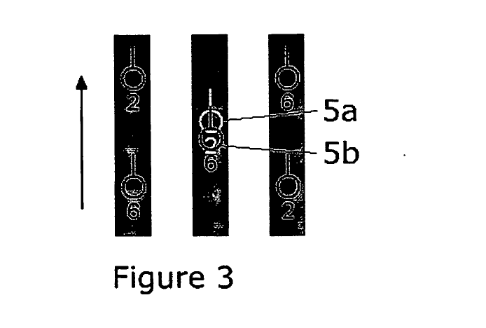

When a plurality of objects or aircraft have a directional relationship within a degree of one another, the symbol 5 for the object that is closest to the aircraft of the user is given priority. This symbol 5 maintains its black coloration while the other symbols are simultaneously shaded or made less prominent by some other means. This produces a better display and provides a guide as to the distance interrelationships among the aircraft. FIG. 3 shows an overlap between two symbols, 5a and 5b. The object at an altitude of 6000 meters is closer than the object at an altitude of 2000 meters, which means that symbol 5a is dimmed by the overlap.

The method and device according to the invention improve the ability of the pilot to maintain his conception of the positions of other objects in relation to his own, regardless of whether or not they are visible in a perspective view, and without the need to glance at other instrumentation in order to update his knowledge concerning said objects. This enables the pilot to focus his attention, and thereby increase his awareness of the situation.

1. A method for displaying surrounding objects on a display surface, comprising:
displaying a first number of objects within selected geographic surroundings in perspective on the display surface,
representing a second number of objects outside of said geographic surroundings, but within a predetermined distance, by symbols in a frame on the periphery of said presentation surface, and
providing a two-dimensional representation of the actual positions of the objects based on placement of the symbols in the frame.

2. A method according to claim 1, wherein symbols representing nearer objects are displayed with greater prominence relative to objects further away.

3. A method according claim 1, wherein the symbols are displayed in accordance with their direction.

4. A device used in an aircraft to display objects surrounding said aircraft, comprising:
means for displaying a first number of objects within selected geographic surroundings as symbols in a perspective view on a display surface,
means for arranging a frame on the periphery of said presentation surface, the frame is being a representation of a selected environment outside of said geographic surroundings, and
means for generating symbols in the frame for representing objects in the selected environment outside of said geographic surroundings.

5. A device according to claim 4, wherein the frame is semi-transparent and superimposed over the perspective view.
